(19) United States
(12) Patent Application Publication
(10) Pub. No.: US 2012/0208394 A1
(43) Pub. Date: Aug. 16, 2012

(54) REUSABLE DOUBLE-CONTACT ELECTRICAL WIRE CONNECTOR FOR SINGLE-AND MULTI-THREAD WIRES

(75) Inventor: Peter Tseng, Taipei Hsien (TW)

(73) Assignee: HEAVY POWER CO., LTD., Taipei Hsien (TW)

(21) Appl. No.: 13/027,310

(22) Filed: Feb. 15, 2011

(51) Int. Cl. H01R 4/24

(52) U.S. Cl. 439/438

(57) ABSTRACT

A double-blade, reusable push-in wire connector for electrically interconnecting together multiple wires has a guide and lock element, which is mated with a conduction and retention element and assembled inside an enclosing element. The guide and lock element has at least one separation wall extending along the direction of insertion of the wires. The conduction and retention element has at least one resilient spring leg and a conduction plate. A wire installation access port is opened in the guide and lock element for force-opening of the clamping between the at least one resilient spring leg and the conduction plate so as to remove an inserted wire from or to insert a multi-thread wire into the connector.

### BACKGROUND

1. Field of the Invention

The present invention relates in general to a push-in electrical connector for wires and, in particular, to an electrical connector for extremely robust connection of multiple wires of either single- or multi-thread using double-contact. More particularly, the present invention is related to such a connector that is reusable.

2. Description of the Related Art

Push-in wire connectors are useful for connecting multiple wires electrically together in applications that include, for example, providing utility power grid for homes and offices, etc. As a good push-in wire connector, electrically it must provide good electrical connection between the connected wires. Further, mechanically it must provide good structural retention that holds the entire connector together with its inserted wires together—regardless of either during the normal conditions of use or after subjected to abuses such as after a fire.

U.S. Pat. No. 7,255,592 to the same applicant of the present invention proposes to resolve the problem of making such a good push-in wire connector. It provides very good electrical connections for all wires joined at the connector by the use of a double-blade electrical contact design. It also simultaneously provides very good structural rigidity as well as very good resistance to abuses such as intentional or accidental yanking—also contributable to its double-blade contact design.

However, this connector allows virtually no reusability. Once a wire is inserted into any channel of the connector, it is virtually impossible to remove without some degree of structural damage to the connector.

Also, this connector does not allow the use of multi-thread wires. Single-thread wires fits perfectly for this connector, but due to its robust double-blade design, a multi-thread wire is virtually impossible to be pushed through the second blade in its assigned channel.

### SUMMARY OF THE INVENTION

It is therefore an object of the present invention to provide a reusable electrical wire connector for electrically connecting multiple wires of either single- or multi-thread together that is optimized in mechanical retention strength among good electrical connection between the wires inserted.

The present invention achieves the above by providing an electrical wire connector for connecting wires electrically together, said connector having a guide and lock means having at least one separation wall extending along the direction of insertion of said wires; a conduction and retention means having at least one resilient spring leg and a conduction plate; and an enclosing means enclosing said guide and lock means mated with said conduction and retention means for securely holding said conduction and retention means therein. The improvement in the connector comprises a wire installation access port opened in said guide and lock means for force-opening the clamping between said at least one resilient spring leg and said conduction plate so as to remove an inserted wire from or to insert a multi-thread wire into said connector.

### BRIEF DESCRIPTION OF THE DRAWINGS

FIG. 1 is an exploded perspective view of the wire connector in accordance with a preferred embodiment of the present invention.

FIG. 2 is a cut-away perspective view of the guide and lock element for the wire connector of FIG. 1.

FIG. 3 is a perspective view of the conduction and retention element for the wire connector of FIG. 1.

FIG. 4 is an exploded perspective view of the conduction and retention element of FIG. 3.

FIG. 5 is a cut-away perspective view of the enclosing element for the wire connector of FIG. 1

FIG. 6 is a cross-sectional view of the wire connector of FIG. 1 in an assembled status.

FIG. 7 schematically illustrates in perspective the configuration of a wire insertion channel for the wire connector in accordance with a preferred embodiment of the present invention.

FIG. 8 is a cross-sectional view schematically illustrating the use of a tool for the facilitation of wire insertion and removal.

### DETAILED DESCRIPTION OF THE PREFERRED EMBODIMENT

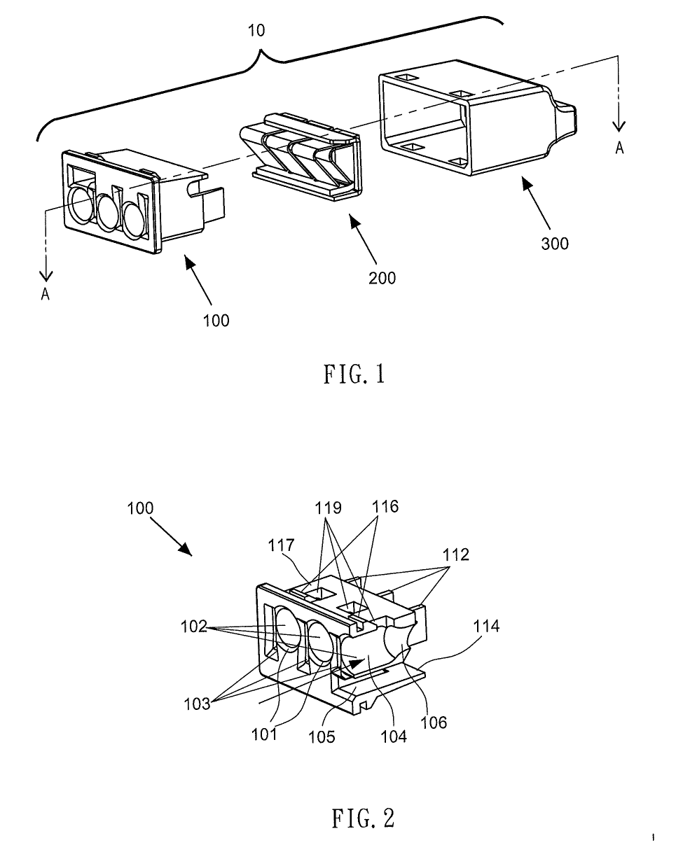

FIG. 1 is an exploded view in perspective of a push-in wire connector in accordance with a preferred embodiment of the present invention. Essentially the wire connector 10 has three components that include a guide and lock element 100, a conduction and retention element 200, and an enclosing element 300. FIG. 6 is a cross-sectional view of a wire connector constructed using such components. With simultaneous reference to FIGS. 1 and 6, a wire connector 10 according to a preferred embodiment of the present invention can be assembled using these three connector elements 100, 200 and 300.

When assembling, the conduction and retention element 200 mates with the guide and lock element 100. The mating then slides into the opening of the enclosing element 300 and is securely locked therein as is depicted in the cross-sectional view of FIG. 6. This is clearly illustrated in the illustration by different shading for each of the three elements 100, 200 and 300.

In mass production of the wire connector, this assembling process is suitable for highly-efficient automation machinery. Meanwhile, it is also suitable for labor assembly due to its simplicity in nature.

As an assembled wire connector 10, the conduction and retention element 200 is securely clamped inside the enclosing element 300 by the guide and lock element 100. The conduction and retention element 200 is able to provide good electrical connection between the wires inserted and pushed into the connector 10 in a mechanically secured manner.

The enclosing element 300, which practically encloses the entire conduction and retention element 200 completely inside, serves to provide electrical insulation for the contacts (between the conduction and retention element 200 and its inserted wires) from the outside. The connector therefore can be used for installation of live wires without risking the user to electrical shocks.

FIG. 2 is a cut away perspective view of the guide and lock element 100 for the wire connector 10 of FIG. 1. Note that the element 100 illustrated in FIG. 2 is shown in an upside-down position as compared to FIG. 1. The illustration reveals a cross section of the element 100 cut along the A-A direction in FIG. 1.

The guide and lock element 100 has multiple (three in the depicted example) wire insertion ports 102 each shaped generally as an elongated hollow opening extending along the direction of wire insertion shown by the arrow. All wire insertion ports 102 are arranged substantially in parallel with the central axis of the hollow opening of each of the ports 102 substantially lying in the same plane.

An entry section 101 for each of the wire insertion ports 102 is an enlarged section generally in the form of a short section of a cone as shown in the drawing. The entry section 101 gradually reduces its size in diameter to that of a main section 104 behind the hollow opening of the port 102. At the end of the main section 104 for each of the insertion ports 102, a shrunk section 106 further reduces the size of the main section 104. This arrangement assists to guide the insertion of a wire pushed into the connector 10 (as is schematically shown in FIG. 2 by the arrow) and toward the desired location inside the connector so as to effect a secured engagement between the inserted wire and the contact portion of the conduction and retention element 200 in the manner to be described subsequently.

Behind the row of wire insertion ports 102 and between every pair of two neighboring ports, an insertion channel separation wall 112 extends along the direction of wire insertion. Each of these separation walls 112 extends from about the end of the wire insertion ports 102 for a length reaching substantially behind the end of the conduction and retention element 200 when assembled. These separation walls 112 serve to provide physical separation between every pair of two neighboring wire insertions so that a wire inserted into one channel does not bend or deflect sideways into the next channel. This is particularly useful for multi-thread wires. Each physical channel established by the separation walls 112 confines all threads—be it the single- or multiple-threads of the inserted wire—within their assigned insertion space so as to be clamped by the mechanical arrangement of the conduction and retention element 200 in a secured manner.

From about the rear end of the main section 104 of the wire insertion ports 102, an alignment plane 114 at the top of the structural body of the guide and lock element 100 (shown up-side-down in this illustration) extends rearwardly along the direction of wire insertion into about midway of the channel separation walls 112. It is used to align and secure the conduction and retention element 200 correctly inside the connector 10 when assembled.

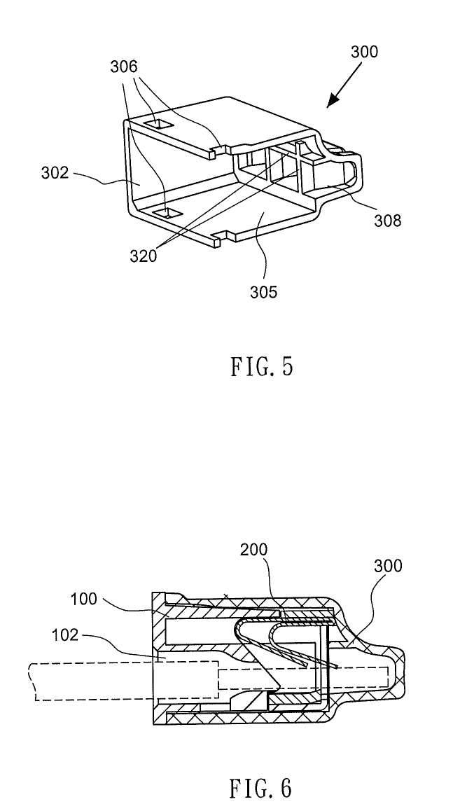

As is illustrated, the surface 117 opposite the alignment plane 114 has at least one enclosure locking means such as a protrusion 116 provided near its leading edge. Not visible in FIG. 2 but visible in FIG. 1, two locking means 116 are preferably formed on the alignment plane 114. These locking means in the form of protrusion are used to engage with their corresponding locking means of the enclosing element 300 in the way to be described with reference to FIG. 5.

In a preferred embodiment of the present invention, as is shown in FIG. 2, the guide and lock element 100 may be equipped with openings 119 formed on the surface 117. Preferably, one inspection opening 119 is formed for each wire channel that provides for visual inspection of the presence and condition of insertion (multi-thread wires, in particular) of any inserted wire. Though, in this case, the enclosing element 300 must be made of transparent material.

Preferably, an electrical test access port 105 can be opened on the front surface of the guide and lock element 100. It provides an access point to check if the push-in electrical connector 10 with one or more wire inserted is live or not. The port 105 permits the insertion of a live-wire test probe or the probe of a voltmeter to physically touch the metallic structure of the conduction and retention element 200. Although any unoccupied port 102 can also be the access port for test because they all allow for access to the double-blade means 230, but the live voltage test port 105 becomes necessary when all ports of a connector 10 are occupied by wire.

Further, to facilitate the use and reuse of multi-thread wires in the electrical wire connector of the present invention, the guide and lock element 100 is equipped with one wire installation access port 103 for each of its wire channels. As is illustrated in FIG. 1 and, in particular, FIG. 2, one such port 103 is formed sideway next to each wire insertion 102 of the element 100. The positioning of this access port allows for the insertion of a tool that forces open the clamping of the connector to allow for either the removal of a wire, either single- or multi-thread, or the installation of a multi-thread wire. Details of how this can be achieved will be described below with reference to FIG. 8.

FIG. 5 is a perspective view of the enclosing element 300 for the wire connector 10 of FIG. 1. Enclosing element 300 is in the shape of a generally solid rectangular box with a wide opening 302 facing toward the direction of wire insertion into the connector. Wide opening 302 allows for the installation of the guide and lock element 100 (together with a conduction and retention element 200 mated therewith) into the enclosing space 305 inside the element 300. Enclosure locking means such as lock openings 306 are formed near the leading edges of the enclosing element 300 at locations corresponding to the locking protrusions 116 of the guide and lock element 100 described above. In the embodiment shown, when both elements 100 and 300 are interlocked to form an assembled connector, each protrusion 116 of element 100 mates with a corresponding lock opening 306 formed on the casing wall of the element 300.

Deep at the end of the internal enclosing space 305 opposite to the wide opening 302 of the enclosing element 300, a wire end extension space 308 may be aligned with the imaginary channels for wire insertion leading from the wire insertion ports 102 when a guide and lock element 100 is assembled in place. The wire end extension space 308 may have a height lower than that of the main enclosing space 305 inside the enclosing element 300. A vertical wall generally identified as 320 helps to secure the conduction and retention element 200 inside the enclosing element 300 in the right position when mated with the guide and lock element 100 and installed therein.

As is comprehensible, both the guide and lock element 100 and the enclosing element 300 are, preferably, made of insulating material commonly used for electric components. Suitable materials such as plastics and the components can be made using, preferably, injection molding technique.

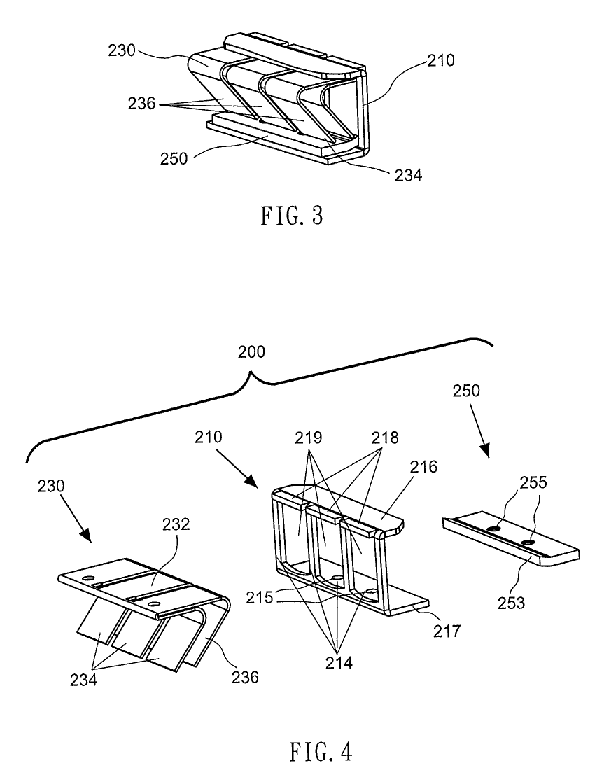

FIG. 3 is a perspective view of the conduction and retention element 200 for the wire connector 10 of FIG. 1. FIG. 4 is an exploded perspective view of the conduction and retention element 200 of FIG. 3. With simultaneous reference to FIGS. 3 and 4, the conduction and retention element 200 in accordance with a preferred embodiment of the present invention may be constructed with a supportive frame 210, a resilient wire retention means 230 and a conduction plate 250.

Overall, the supportive frame 210 is substantially in the shape of a framed structure that has multiple window openings when observed along the direction of wire insertion into the connector. Note that the number of window openings—three in this depicted example—is the same as the number of wire insertion ports 102 the wire connector 10 has.

The supportive frame 210 may be made using one single piece of metal plate, preferably an alloy, preferably by stamping or press-forming. The shaping of its making forms the windows 219 separated by window pillars 214. The frame body is bent substantially into a square C-shaped cross section with top and bottom extension plates 216 and 217 extending against the direction of wire insertion. Note that the top extension plate 216 may further have small extensions 218 for each window 219 that extends in the opposite direction. These small extensions increase the overall length of the top plate 216 for each window 219 in the direction of wire insertion. They serve to facilitate a more stable and secured mating between the frame 210 and the resilient wire retention means 230, as will be explained below.

With window pillars 214 in the Z direction and the extension plates 216 and 27 in the X-Y plane of an imaginary coordinate system, the structure essentially establishes a three-dimensional configuration that is robust in structural strength to be mated with the resilient wire retention means 230, also to be explained below.

On the inner (top) surface of the bottom extension plate 217, a couple of small protrusions 215 are formed each at, preferably, about one-third the width of the plate 217. They are used to be mated with corresponding small holes 255 formed on the corresponding locations of the conduction plate 250. The dimensions of the protrusions 215 and the holes 255 can be made so that once the conduction plate 250 is pressed onto the top surface of the extension plate 217 of the frame 210 in a production procedural step, they are fixedly connected together.

The conduction plate 250, as is illustrated in the exploded view of FIG. 4, is an electrically conductive metallic or alloy plate having a width substantially comparable with that of the resilient wire retention means 230 and the supportive frame 210. The wide but short (observed along the direction of wire insertion) conduction plate 250 has a curved-up bent 253 at the trailing (again along the direction of wire insertion) edge of the plate. Together with the pressing down of the double blades (234 and 236) of the resilient wire retention means 230, this bent 253 serves to prevent the dislodge of the inserted wire in each port of the connector 10 when it is pulled in the direction opposite the insertion.

Observed sideways, as can be seen in FIG. 4, resilient wire retention means 230 takes the shape of a fall-down double-J, one that with a tall J behind a short one. Extending against the direction of wire insertion from the edge of the horizontal top plate 232 (or, the back of the larger J) of the resilient wire retention means 230, a number of resilient spring legs 236 bend down and backward toward the direction of wire insertion. The total number of resilient spring legs 236 corresponds to the total number of wire insertion ports 102 formed in the guide and lock element 100. The bending of the resilient spring legs 236 is preferably at an angle of less than 90 degrees (into the direction of wire insertion) with respect to the top plate 232.

A second set of resilient spring legs 234 (that of the smaller J) bend at substantially the same angle as that of the legs 236 extend from the bottom surface of the top plate 232 of the resilient wire retention means 230. As is illustrated, resilient spring legs 234 come behind legs 236 in the direction of wire insertion. Pressing against the top surface of the conduction 250 when assembled as shown in FIG. 3, both legs for each wire insertion port serve the function of a double-blade mechanism that grabs any inserted wire, either single- or multi-thread, firmly to allow no removal—unless the blades are pushed open.

Installation of wires in the electrical wire connector of the present invention is so firm that the facilitation of the use and reuse of wires, either single- or multi-thread, requires the use of an installation tool. Without the use of the tool, the disengagement of any installed wire from the connector is virtually impossible. In case of a fire, even if the plastic enclosing element 300 and the guide and lock element 100 were consumed, the clamping of the wires by the double-blade mechanism will still hold. In other words, an installation tool renders the connector reusable. As is best seen in FIG. 2, the guide and lock element 100 has one wire installation access port 103 for each of its wire channels, and the cross-sectional view of FIG. 8 schematically illustrates the use of a tool for the facilitation of wire insertion and removal.

One such wire installation access port 103 is formed sideway next to each wire insertion 102 of the element 100. In FIG. 8, a special blade-tipped, screwdriver-like tool, for example, can be pushed into the access port so that the tips of the resilient legs (236 and 234 in FIGS. 3 and 4) can be lifted up away from the conduction plate 250 of the conduction and retention element 200. With the clamping forced open, user can either install a multi-thread wire or remove an already installed wire—either single- or multi-thread wire.

Similar as with the supportive frame 210, the resilient wire retention means 230 can also, and preferably, be made out of a metal plate. In a preferred embodiment of the present invention, the resilient wire retention means 230 can be produced using a press-forming sequence. As illustrated (in FIGS. 4 and 8), the multiple double J-shaped legs are simply formed out of one single piece of metal by stamping, folding back, and then bending.

As is comprehensible, supportive frame 210, resilient wire retention means 230 and conduction plate 250 can be made of metallic or, preferably, alloy material. Alloy supportive frame 210 is advantageous in providing structural sturdiness for the entire assembled conduction and retention element 200 illustrated in FIG. 3. Alloy for the resilient wire retention means 230 can be selected to sustain resilience when the resilient spring legs 234 and 236 are slightly bent upward due to wire insertion. Alloy for the conduction plate 250, on the other hand, can be selected to provide good electrical conductivity. Preferably, conduction plate 250 should be made of copper alloy sheets with greater than 58 percent copper content. Also as is comprehensible, each and everyone of the supportive frame 210, the resilient wire retention means 230 and conduction plate 250 can be made via press-forming manufacturing technique.

In a preferred embodiment of the present invention, all parts for the conduction and retention element 200 are fixedly assembled into one single component. The assembled conduction and retention element 200 can then be mated with the guide and lock element 100 and then installed and locked inside the enclosing element 300. The assembly of the conduction and retention element 200 as one single component is achievable via, preferably, mutual-interlocking structural mating between its supportive frame 210, resilient wire retention means 230 and conduction plate 250—without other means such as, for example, welding. Whenever desirable, though, permanent means such as spot-welding can be used to fix the resilient wire retention means 230 and the conduction plate 250 onto the supportive frame 210.

FIG. 6 is a cross-sectional view of the wire connector shown in the exploded view of FIG. 1 as it is assembled using the three elements including the guide and lock 100, the conduction and retention 200 and the enclosing element 300. The cross-section view shows that the conduction and retention element 200 is matched and securely fixed inside the structural body of the connector 10. This secured installation of the conduction and retention element 200 inside the enclosing element 300 and behind the guide and lock element 100 allows wires to be inserted into the wire connector 10 for facilitating electrical conduction therebetween. Compact and tight assembly of the three elements ensures that wire ends can be securely held to the connector while sustaining good electrical conductivity between all the inserted wires.

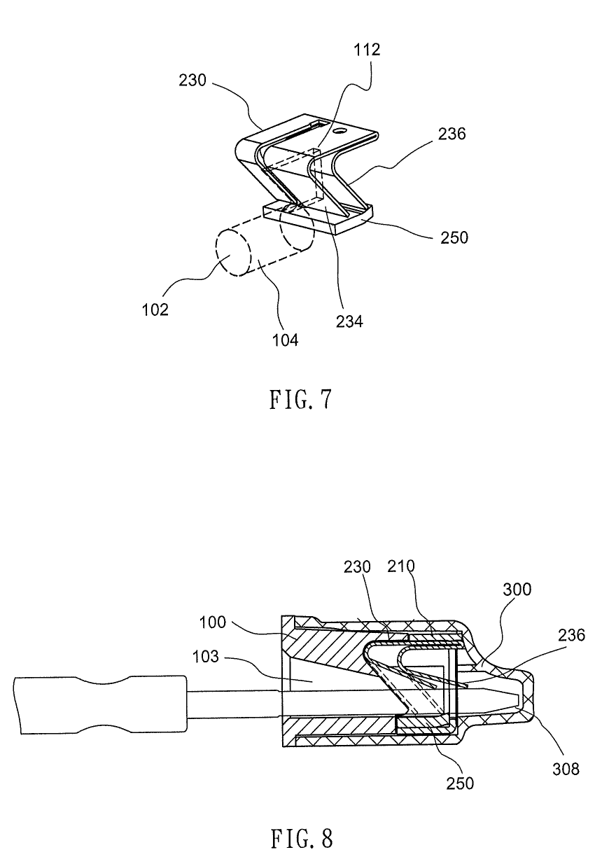

FIG. 7 schematically illustrates in perspective the configuration of a wire insertion channel for the wire connector in accordance with a preferred embodiment of the present invention. Three wire insertion channels are present in the described embodiment of the present invention as depicted in the drawing. The imaginary wire insertion channel outlined in FIG. 7 starts with a main port section 104 (schematically shown in FIG. 7 in phantom as a cylindrical tube) led in from a wire insertion port (102 in FIG. 2) at left and then followed by a wire engagement segment to the right. The wire engagement segment, as shown in the drawing, is formed by the surrounding of the conduction plate 250 at the bottom, the insertion channel separation wall 112 at one or both sides, and the resilient spring legs 234 and 236 on the top.

In the depicted three-channel example of the drawing, the central channel has both sides surrounded by insertion channel separation walls 112 while the two side channels each has an insertion channel separation wall 112 at the inner side and the sidewall of the enclosing element 300 at the outer side.

Thus, all three wire insertion channels, whether central or side, has a wire engagement segment that has all sides properly enclosed. Such a complete four-way and all-surrounding enclosure prevents the inserted wire end from being bent sideways and deflects out of its assigned insertion channel. Each stripped wire end of a wire pushed into the connector can then pass on and enters into the wire end extension space 308 inside and at the back of the enclosing element 300. However, as is comprehensible, a wire connector in accordance with the present invention may also be made without a wire end extension space 308 inside and at the back of the enclosing element. This is because a stripped wire end of an inserted wire can be held sufficiently secure within the wire engagement segment of its insertion channel.

While the above is a full description of the specific embodiments, various modifications, alternative constructions and equivalents may be used. Therefore, the above description and illustrations should not be taken as limiting the scope of the present invention, which is defined by the appended claims.

What is claimed is:

1. A connector for electrically connecting wires together comprising:
guide and lock means having at least one separation wall extending along the direction of insertion of the wires;
conduction and retention means having at least one resilient spring leg and a conduction plate;
enclosing means enclosing said guide and lock means mated with said conduction and retention means for securely holding said conduction and retention means therein; and
a wire installation access port opened in said guide and lock means for force-opening clamping between said at least one resilient spring leg and said conduction plate by pushed-in insertion of a tool so as to remove an inserted wire from or to insert a multi-thread wire into the connector.

2. The connector of claim 1 wherein the tool forces open the clamping by lifting said at least one resilient spring leg from said conduction plate.

3. The connector of claim 1 wherein said guide and lock means comprises at least two wire insertion ports each leading to a main port section for receiving the insertion of a stripped end of the wires.

4. The connector of claim 1 wherein said conduction and retention means further comprises a supportive frame having a three-dimensional structural configuration with a C-shaped cross section that includes a top extension plate and a bottom extension plate extending against the direction of wire insertion into the connector.

5. The connector of claim 3 wherein said supportive frame is made from a single metallic plate by press-forming and stamping.

6. The connector of claim 1 wherein said at least one resilient spring leg is made from a single metallic plate by press-forming and stamping.

7. A connector for electrically connecting wires together comprising:
a guide and lock element having at least one separation wall extending along the direction of insertion of the wires;
a conduction and retention element having at least one resilient spring leg and a conduction plate;
an enclosing element enclosing said guide and lock element mated with said conduction and retention element for securely holding said conduction and retention element therein; and
a wire installation access port opened in said guide and lock element for force-opening clamping between said at least one resilient spring leg and said conduction plate by pushed-in insertion of a tool so as to remove an inserted wire from or to insert a multi-thread wire into the connector.

8. The connector of claim 7 wherein the tool forces open the clamping by lifting said at least one resilient spring leg from said conduction plate.

9. The connector of claim 7 wherein said guide and lock element comprises at least two wire insertion ports each leading to a main port section for receiving the insertion of a stripped end of the wires.

10. The connector of claim 7 wherein said conduction and retention element further comprises a supportive frame having a three-dimensional structural configuration with a C-shaped cross section that includes a top extension plate and a bottom extension plate extending against the direction of wire insertion into the connector.

11. The connector of claim 10 wherein said supportive frame is made from a single metallic plate by press-forming and stamping.

12. The connector of claim 7 wherein said at least one resilient spring leg is made from a single metallic plate by press-forming and stamping.
